(19) United States
(12) Patent Application Publication
(10) Pub. No.: US 2009/0288014 A1
(43) Pub. Date: Nov. 19, 2009

(54) Widget platform, system and method

(76) Inventor: Robb Fujioka, Manhantan Beach, CA (US)

Correspondence Address: Thomas J. McWilliams, Esquire;Drinker Biddle & Reath LLP,, One Logan Square, 18th and Cherry Streets, Philadelphia, PA, 19103-6996, US

(21) Appl. No.: 12/383,001

(22) Filed: Mar. 17, 2009

Related U.S. Application Data
(60) Provisional application No. 61/069,777, filed on Mar. 17, 2008.

(51) Int. Cl. G06F 3/048; G06F 3/01; G06F 17/30; G06Q 30/00; G06Q 50/00

(52) U.S. Cl. 715/745; 715/762; 707/3; 705/14.45; 707/E17.014

(57) ABSTRACT

A widget platform is disclosed. The widget platform includes a plurality of widget templates, a plurality of widget code portions, wherein at least a portion of the code portions are available for placement into ones of the plurality of widget templates, a search engine, wherein the search engine locates, responsive to a request, ones of the plurality of widget code portions, and a publisher, wherein the publisher publishes, responsive to a publication instruction, at least one widget prepared in accordance with at least one of the plurality of widget templates.

### RELATED APPLICATIONS

This application claims priority to U.S. Provisional Patent Application No. 61/069,777 entitled “A Widgetized Platform, System and Method” filed Mar. 17, 2008 naming as an inventor Robb Fujioka, the entirety of which is incorporated herein as if set forth in its entirety.

### FIELD OF THE INVENTION

The present invention relates generally to computerized widgets, and, more specifically, to a widget platform, system and method.

### BACKGROUND OF THE INVENTION

Many computing and entertainment embodiments allow for a user, player, or viewer to create an “avatar.” An avatar is typically a virtual manifestation of that user's “computerized physicality.” However, the prior art typically provides only limited options for a user who wishes to create an avatar, such as limited physical features, clothing, associated information, and the like. As such, a typical avatar allows for only very limited information about a user to be relayed by the avatar. More specifically, the physical characteristics of the avatar likely have only limited applicability to the physicality of the real-world user, due in part to the limited physical, clothing and the like options available in creating the avatar, and the typical information associated with the avatar, other than its physicality, is limited or non-existent.

Additionally, present avatars need to be created over and over again, and are highly variable for the same real user as between different applications using an avatar, in principal part because avatars are not typically transferable as between multiple applications. Further, present avatars present little or no monetization or marketing opportunities, nor do present avatars allow for collection of or provision to, potential transaction partners of the preferences, characteristics or interests of the actual user.

Thus, the need exists for an avatar, and an apparatus, system and method related thereto, that allows for transferability, improved physical relation to the actual user, more information regarding the actual user, and improved marketing, monetization and transaction opportunities related to the user's avatar.

### SUMMARY OF THE INVENTION

A widget platform is disclosed. The widget platform includes a plurality of widget templates, a plurality of widget code portions, wherein at least a portion of the code portions are available for placement into ones of the plurality of widget templates, a search engine, wherein the search engine locates, responsive to a request, ones of the plurality of widget code portions, and a publisher, wherein the publisher publishes, responsive to a publication instruction, at least one widget prepared in accordance with at least one of the plurality of widget templates.

A widget platform configured to track widgets is disclosed. The widget platform configured to track widgets includes a plurality of widget templates, a plurality of widget code portions, wherein at least a portion of the code portions are available for placement into ones of the plurality of widget templates, and at least one embedded code portion, the at least one embedded code portion including a match with, and embedded portion within, the plurality of widget code portions, and the at least one embedded code portion including a tracker of user actions associated with at least one of the plurality of widget code portions.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts:

FIG. 1 illustrates content links that are authorized for incorporation into the widget, or a dropdown menu from which the user can select authorized types of content for that portion of the widget, or a hierarchal dropdown menu from which the user may select a top level, and subsequently more specific levels of allowed content from the available authorized content according to an aspect of the present invention;

FIG. 2 illustrates a widget that may be designed for interest in, or capability of, playing within the widget of particular video games according to an aspect of the present invention;

FIG. 3 illustrates a widget for specific geographic locations that may access the location of the user requesting the use of that particular widget, such as by the physical location of the IP address of such user, and may fill in the selected widget based on the user's geographic location according to an aspect of the present invention;

FIG. 4 illustrates a flow diagram including a widget aggregator according to an aspect of the present invention;

FIG. 5 illustrates a widget used in a television or DVR computing community according to an aspect of the present invention; and

FIG. 6 illustrates that the subject widget may be published into an active program according to an aspect of the present invention.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in typical widget and computing apparatuses, systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

A widget in accordance with the present invention, and as will be understood by one of ordinary skill in the art, is a portable portion of code that may be installed or executed within any separate HTML based webpage by an end user without necessitating additional compilation of that code portion. Such widget code portions, in accordance with the present invention, are embeddable by the end user. As such, a widget in accordance with the present invention is any code portion that may be embedded by the end user within a selected page of HTML, XML, or like code that causes presentation of that selected web page. The widget, via the embedded code portion, thereby adds non-static content to the subject webpage.

A widget in accordance with the present invention may allow a user to take a discreet portion of a favored user experience on a network, such as a portion of favorite interactive information, a favorite website, or a particular application, and transport that favorite portion for use in an approved on-line experience targeted to the particular interests of that user. For example, such a widget constituting a discreet portion of a favored user experience may be applied to a desktop or web top experience to personalize such a desktop or web top experience to that particular user. Further, such widgets in the present invention may allow for transport of a favored user experience to other user experience locations, such as computing communities and/or social networking sites, in order to improve that user's experience of such other sites or network locations. Needless to say, as used herein a network or network experience is and includes an internet, intranet, extranet, telecommunications network, and any other network experience that allows for importation of the widget concept.

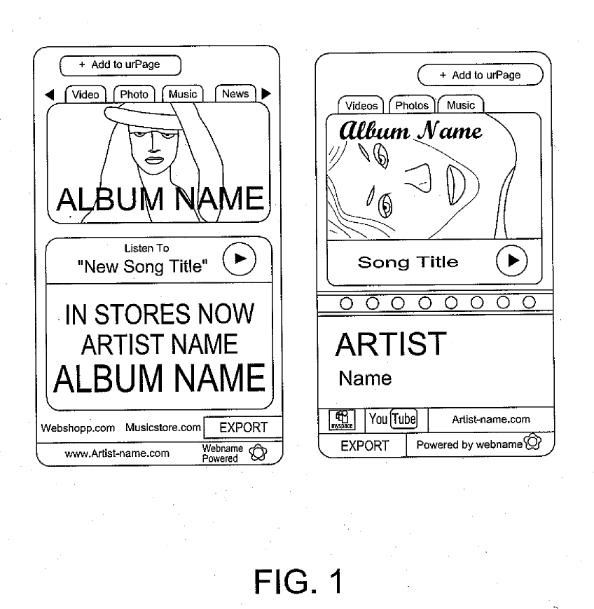

In an exemplary embodiment of the present invention, the widgets may be located by a user, or designed by a user, in accordance with preferred techniques. Such preferred techniques may include, for example, in the case of the user-defined widget, the provision of widget templates, into which a user may develop that user's own unique widgets by using discreet physical locations within such template to place code for the subject widget in an overall widget physical format provided by the template. For example, such a widget template may be divided into fields, wherein a user may be given discreet options for each portion of the field as to what widget content the user wishes the ultimate widget to have in that field. For example, the user may click on a particular field, such as the upper left quadrant of the subject widget as illustrated in FIG. 1, and may be presented with a series of content links that are authorized for incorporation into the widget, or a dropdown menu from which the user can select authorized types of content for that portion of the widget, or a hierarchal dropdown menu from which the user can select a top level, and subsequently more specific levels of allowed content from the available authorized content. Further, the use of particular content in one portion of a widget template may limit the allowable content in other portions of the widget template. For example, once a user elects to have a quadrant of a widget themed in accordance with a particular musical artist, the template may limit the allowable artists that may be involved in other portions or quadrants of the widget template. For example, in the event that an active aspect for the overall widget is incorporated into the upper left quadrant of FIG. 1 in relation specifically to musical artist Eminem, and thereby at least a portion of the widget code relates to artist Eminem, the options available for the remainder of the widget may be limited only to those relating to musical artist Eminem: that is, for musical widget content, all of the code for the overall widget must relate to the artist Eminem. Upon design of a widget, the user may “publish” the widget to a desired location.

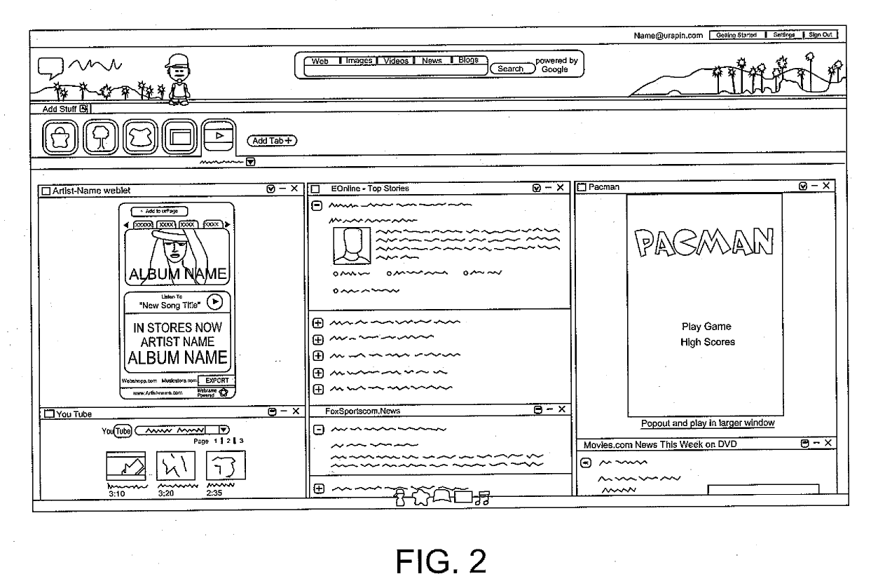

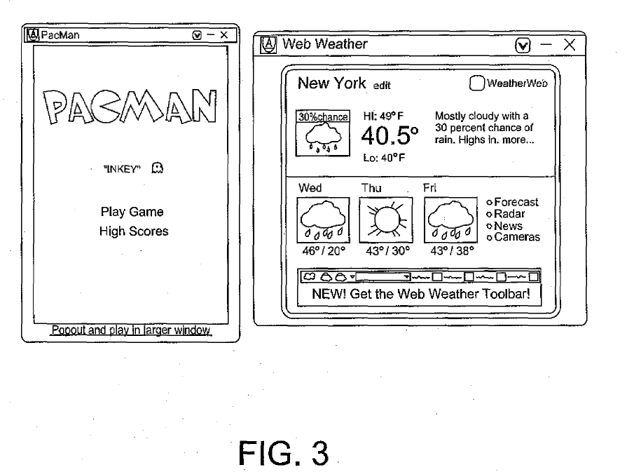

Additionally, a library of existing widgets may be designed to be made available to improve the user experience upon use of a particular web top or desktop. Such a library may be available via a particular website, via a web top application, via a desktop application, or via discreet application, for example. For example, under the assumption that rights are obtained to create widgets for placement into the library with regard to all artists operating under a particular music recording label, widgets may be designed for placement into the library for all artists recording under that music label. Similarly, widgets may be designed for interest in, or capability of, playing within the widget of particular video games, such as “antique” video games, as illustrated in FIG. 2. Other widgets that may be placed into such a library may require no licensing to allow for creation of the widgets. For example, a weather widget, or a traffic widget, may be developed for specific geographic locations, or may be generically developed and may access the location of the user requesting the use of that particular widget, such as by the physical location of the IP address of such user, and may fill in the selected widget based on the user's geographic location, as illustrated in FIG. 3. In such examples, a weather widget may be made available with up to the minute radar, immediate forecast, projected seven day forecast, current airport conditions, road conditions, or delays, and the like. Similarly, traffic updates may be made available in a traffic widget for certain local roads, which local roads may be selectable as roads of interest to the user upon selection of the particular traffic widget from the widget library. Examples of predefined music widgets, video game widgets, and weather widgets, as discussed immediately hereinabove, are illustrated in FIG. 3.

Similarly, the present invention includes a fully portable, widgetized avatar having associated therewith multiple items of information and/or social information that may be generally searched for and/or otherwise requested for association with at least two different computing communities or transactions. Widgetization of the avatar of the present invention necessarily allows for portability of the avatar of the present invention. For example, widgetization of a typical avatar in accordance with the present invention may include the association of physical features, such as facial and hair, with the subject avatar, as well a user name. Further, a myriad of additional information may be associated with the avatar, wherein such information is generally required or desired for use in computing communities or transactions, such as search transactions. This information may be organized into multiple levels of detail and/or multiple levels of accessibility to third parties in a computing community or transaction. Such levels of accessibility may be selected by the creator of the widgetized avatar, and may be based on characteristics of the third party endeavoring to access the subject avatar. For example, a user may have basic information, which may be selectable for viewing by all registered users.

In an exemplary embodiment, a user may have likes or dislikes, such as musical or motion picture tastes, job or educational status, age, location, income, marital status, and other computed communities with which that user is associated, associated with his or her avatar, and each such like or dislike may have associated therewith a widget code portion.

The present invention may provide a physical manifestation of all of this information such as in a “trading card” format widget. For example, the front of the virtual trading card may include an avatar having particular physical features, clothing, accessories, activities, likes, dislikes and expertise, and the like, along with an associated user name. However, when an interaction, such as selection of a drop-down menu, selection of a link, a double click, or the like is undertaken to “flip” a trading card to the back, a myriad of additional information is displayed regarding the user related to the widgetized avatar, such as age, interests, likes and dislikes, employment status, and the like.

It will be apparent to those skilled in the art that providing a widget library to users will provide to the user great flexibility in improving the user's experience of the web top, desktop, or other network experience into which the user incorporates such widgets. In order to provide further flexibility and ease of user experience, such a widget library may be made available to the user in a format that will allow the user to readily locate a widget, widget portions or widgets of interest. For example, a widget directory, such as a hierarchal widget directory, may be provided in accordance with the present invention, and such directory may further be provided with an interface that allows for successive level searching to assist users in finding and adding widgets or widget portions of interest to improve the user's experience. For example, a user may be enabled to search by any one or more of known methods for a widget or widget portion of interest, or all widgets related to a topic of interest, such as by searching alphabetically, by key word, by topical area, and the like, and upon selection of any widget category that the user has sought, the user may be provided with widgets falling into that category, or the user may be provided with an additional set of selectable variables that will allow the widget entities within the library to be further narrowed before presentation to the user for choice by the user.

Additionally, such a user searching feature may include wish lists, hot topics, or collections that may be developed or entered by the user, in which the user may request alerts when desired widgets or widget portions are available, the user may request alerts to the availability of other widgets in another topical area of interest, or the user may wish to aggregate widgets by interest group, or topical keyword, so that the user may have ease of creating and publishing, or downloading, or otherwise accessing in large quantities.

It is desirable, in accordance with the present invention, and in order to best improve the user experience, to allow for third party content providers to employ an interface or one or more templates to create widgets that they believe their users, listeners, viewers, or fans would most like to download in order to improve the user experience. Thus, the present invention may include a widget creation and/or upload tool, whereby a third party may be provided with one or more templates from which that third party may create a widget. For example, the third party may wish for inclusion of particular audio, video, or audio visual works in a widget directed to the fans of that particular third party. Further, the third party may make available particular still photos, commentaries or critiques, press releases or reviews, caricatures or parodies, logos or artistic designs, technologies and/or research, or requests for information and/or partners, as part of that third party's widget design. Needless to say, third parties may create multiple widgets in order to target multiple users for fans of that third party having different interests.

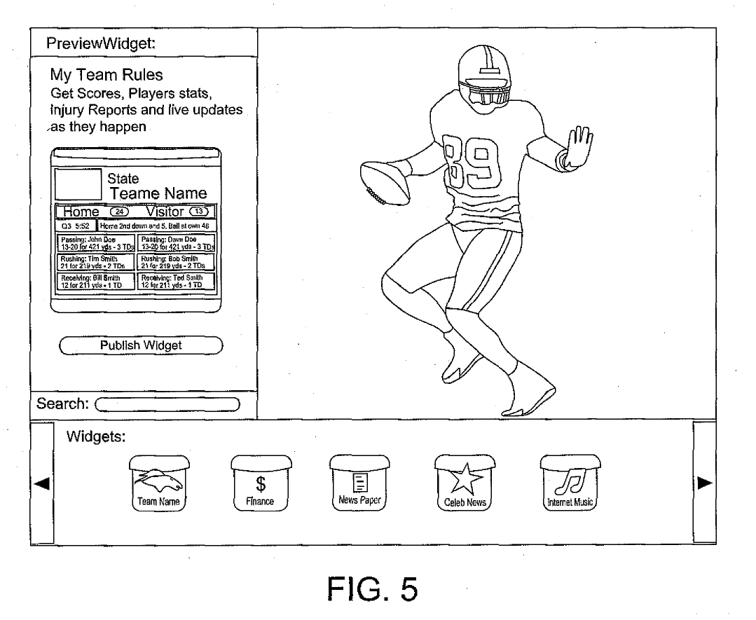

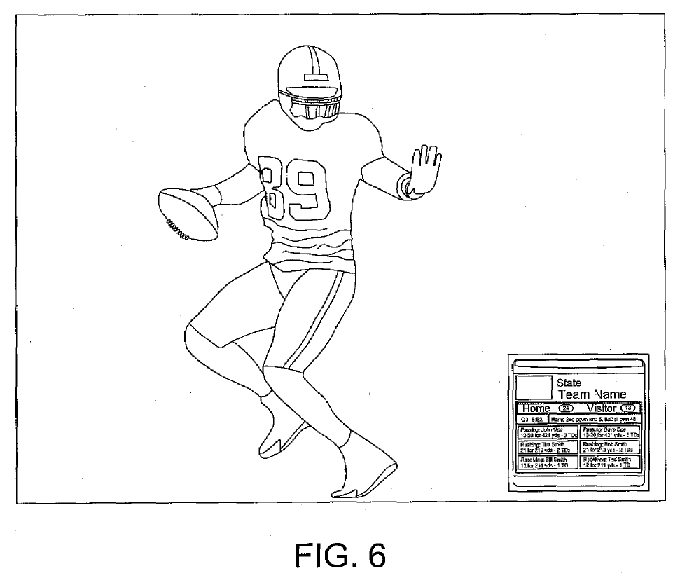

Further, for example, widgets may be combination of third party published widgets and user designed widgets. For example, FIG. 5 illustrates a widget used in a television or DVR computing community. In the illustrated embodiment, numerous widgets or widget templates may be made available, such as for selection from a menu. In the illustrated embodiment, a National Football League widget is made available, and is selected by the user for publication. The user may select what scores, statistics, or the like are to be included in the widget upon publication. As illustrated, other widgets may be available to the user, as may be a widget search mechanism as described herein. FIG. 6 illustrates that the subject widget may be published into an active program. As is typically the case with widgets, the widget code need not be compiled, and thus may run simultaneously with the program code of the illustrated football program. For example, such as through the use of a metadata stream corresponded to the television program, the widget may be overlayed on the screen. Thereby, a viewer of one television program may select a widget that may provide information about other matters not then being viewed by the program viewer. Thus, for example, a user can track fantasy sports information while watching a sporting event, may track news while watching a sitcom, or the like.

Through the use of the present invention, widgets may be tracked. For example, widgets of the present invention may be associated with a cached identification, which is matched to the widget, and as such each time the widget is dragged and dropped downloaded, or otherwise moved and/or used in a user's desired location, such as a web top, the movement and/or download of the widget is tracked. As such, information with regard to the party's dragging and dropping the widget, or the point to point locations from which a widget is dragged and dropped each time that widget is dragged and dropped, may be tracked by tracking of the associated cached identification. As such, particular metrics, such as Google® metrics, may be associated with each widget, and the use of each widget. Such tracking information may be provided, such as to the publisher, i.e., the third party creator, of a particular widget, in order that the publisher may be enabled to make an accounting for the use and/or download of the widget. Thereby, payment methodologies may be associated with the use and/or download of the widget.

Additionally, for example, as will be understood by those skilled in the art in light of the discussion herein, in embodiments wherein the certain characteristics of a user are known to the search engine of the present invention, the downloading of widgets in accordance with the present invention allows for a monitoring of who performed a search, what they deemed most relevant responsive to it, and what was done responsive to that relevance, such as the downloading of a widget. Thus, again, the present invention may include an advanced marketing and sales tool.

Further, discretely or in association with the aforementioned tracking of widgets, the use of particular widgets may allow for assumptions with regard to the interest of the downloading-user of the subject widget. Thereby, monetization, such as advertising monetization, may be associated with the user of the subject widget, such as by allowing for the presentation to the user of particular advertisements, such as from an advertising server, based on the user's use or download a particular widget. Further such advertising may be directly associated by the publisher of the subject widget for presentation to the user of the subject widget at predetermined times, or upon predetermined uses of the subject widget. For example, a publisher, i.e., a third party creator, of a subject widget may determine that an advertisement related to that publisher is displayed to a user at least once per week following the downloading by that user of a widget associated with that publisher.

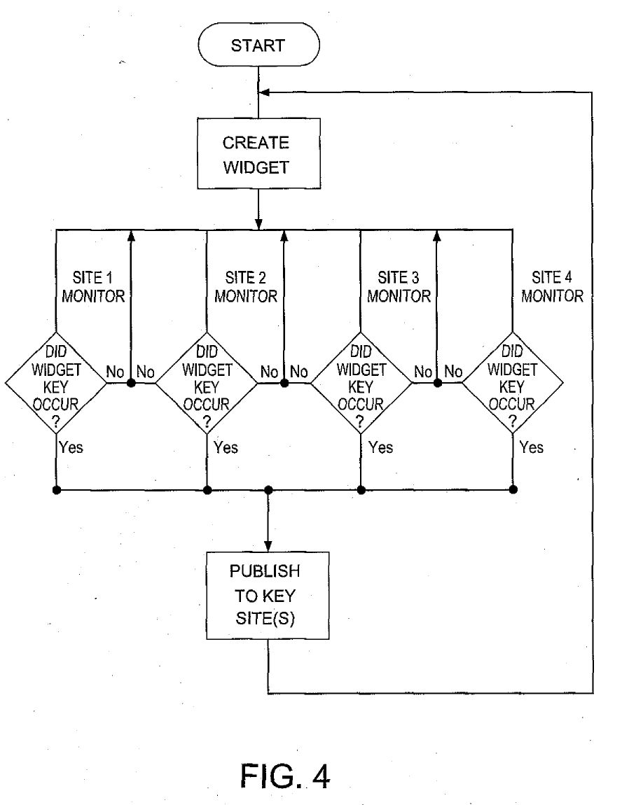

The present invention may further include a widget aggregator. Such a widget aggregator is illustrated in the flow diagram of FIG. 4. The widget aggregator may, upon publishing of a particular widget, allow for selection by the publisher of a myriad of keys that, upon occurrence of those keys in any location within the aggregated universe selected by the publisher, will cause publication, use, and/or download of the select widget into the particular location. For example, the aggregator may allow for the publisher to request publication of the subject widget into one or more of multiple travel-related internet sites, such as Expedia.com or Travelocity.com, upon occurrence of one or more circumstances in relation to a user of those travel sites. Thereby, the present invention eliminates the necessity of a design of a widget for each desired publication site for a widget, such as in the instance where the desired universe of sites may be quite large.

Those of ordinary skill in the art may recognize that many modifications and variations of the present invention may be implemented without departing from the spirit or scope of the invention. Thus, it is intended that the present invention covers the modifications and variations of this invention provided they come within the scope of the appended claims and their equivalents.

What is claimed is:

1. A widget platform, comprising:
a plurality of widget templates;
a plurality of widget code portions, wherein at least a portion of said code portions are available for placement into ones of said plurality of widget templates;
a search engine, wherein said search engine locates, responsive to a request, ones of said plurality of widget code portions; and
a publisher, wherein said publisher publishes, responsive to a publication instruction, at least one widget prepared in accordance with at least one of said plurality of widget templates.

2. The platform of claim 1, wherein said plurality of widget code portions comprises within a separate HTML based webpage by an end user.

3. The platform of claim 1, wherein said plurality of widget code portions are embeddable by the end user.

4. The platform of claim 1, wherein said plurality of widget code portions comprises non-static content to the subject webpage.

5. The platform of claim 1, wherein said plurality of widget code portions comprises a discreet portion of a favored user experience on a network.

6. The platform of claim 1, wherein said plurality of widget code portions comprises a personalization of the favored experience to a particular user.

7. The platform of claim 1, wherein said plurality of widget code portions comprises transportability of a favored user experience to other user experience locations.

8. The platform of claim 7, wherein the other user experience locations include at least one of another computing community and a social networking site.

9. The platform of claim 1, wherein said plurality of widget code portions is at least one of located by a user and designed by a user.

10. The platform of claim 1, wherein said plurality of widget templates is at least one of located by a user and designed by a user.

11. The platform of claim 1, wherein said plurality of widget templates is divided into at least one field.

12. The platform of claim 11, wherein said at least one field provides a user with at least one discrete option associated with said at least one field.

13. The platform of claim 12, wherein the at least one discrete option includes widget content the user wishes the widget to have.

14. The platform of claim 12, wherein particular content selected to use in said at least one field limits allowable content for in other portions of the widget template.

15. The platform of claim 1, wherein said publisher publishes to a library of existing widgets.

16. The platform of claim 15, wherein said library is available via at least one of a particular website, a web top application, a desktop application, and a discreet application.

17. The platform of claim 1, wherein said plurality of widget templates comprises at least one video game.

18. The platform of claim 1, wherein said plurality of widget code portions comprises at least one video game.

19. The platform of claim 1, wherein said plurality of widget code portions comprises a weather widget.

20. The platform of claim 19, wherein said weather widget identifies a geographic location of a user.

21. The platform of claim 1, wherein said plurality of widget code portions comprises a traffic widget.

22. The platform of claim 21, wherein said traffic widget identifies a geographic location of a user.

23. The platform of claim 1, wherein said plurality of widget code portions comprises a fully portable, widgetized avatar.

24. The platform of claim 23, wherein said avatar is manifested as a trading card.

25. The platform of claim 24, wherein said trading card may be visually flipped by at least one of a drop-down menu, a selection of a link and a double click.

26. The platform of claim 1, wherein said search engine includes a widget directory.

27. The platform of claim 26, wherein said widget directory is a hierarchal widget directory.

28. The platform of claim 26, wherein said widget directory includes an interface for successive level searching.

29. The platform of claim 1, further comprising a widget creator.

30. The platform of claim 1, further comprising an upload tool.

31. The platform of claim 1, wherein said publisher comprises publishing into an active program.

32. The platform of claim 31, wherein the publish into an active program comprises metadata stream corresponded to a television program.

33. The platform of claim 32, wherein the publish overlays the metadata on a display of the corresponded television program.

34. The platform of claim 31, wherein the publish into an active program comprises the publishing of a widget relating to matters not then being viewed by a user.

35. A widget platform configured to track widgets, said platform comprising:
a plurality of widget templates;
a plurality of widget code portions, wherein at least a portion of said code portions are available for placement into ones of said plurality of widget templates; and,
at least one embedded code portion, said at least one embedded code portion comprising a match with, and embedded portion within, said plurality of widget code portions, and said at least one embedded code portion comprising a tracker of user actions associated with at least one of said plurality of widget code portions.

36. The widget platform of claim 35, wherein said at least one embedded code portion comprises a cached identification to track said at least one embedded code portion each time said at least one embedded code portion is downloaded.

37. The widget platform of claim 35, wherein said tracker comprises information including a publisher of said plurality of widget code portions.

38. The widget platform of claim 35, further comprising at least one payment associated with said tracker.

39. The widget platform of claim 35, further comprising a marketing tool, said marketing tool utilizing said at least one embedded code portion to increase use of said plurality of widget code portions.

40. The widget platform of claim 39, wherein said marketing tool includes particular advertisements based on use of a particular one of said plurality of widget code portions.

41. The widget platform of claim 40, wherein the particular advertisements are returned from an advertising server.

42. The widget platform of claim 35, further comprising a widget aggregator, said widget aggregator allowing for publication of at least one of said plurality of widget code portions into selected internet sites upon occurrence of one or more circumstances in relation to a user of said internet sites.

43. The widget platform of claim 42, wherein the selected internet sites comprises travel related internet sites.
